(19) United States
(12) Patent Application Publication
(10) Pub. No.: US 2024/0046812 A1
(43) Pub. Date: Feb. 8, 2024

(54) SYSTEMS AND METHOD FOR A DECENTRALIZED ENVIRONMENT TRAINER FOR PHYSICAL DEPLOYMENT

(71) Applicant: BANK OF AMERICA CORPORATION, Charlotte, NC (US)

(72) Inventor: Manu Jacob Kurian, Dallas, TX (US)

(73) Assignee: BANK OF AMERICA CORPORATION, Charlotte, NC (US)

(21) Appl. No.: 17/879,175

(22) Filed: Aug. 2, 2022

(51) Int. Cl. G09B 9/00; G09B 19/18

(52) U.S. Cl. CPC G09B 9/00; G09B 19/18

(57) ABSTRACT

Systems, computer program products, and methods are described herein for a decentralized virtual environment platform with transition modules between virtual and physical environments. The present invention is configured to allocate modules in a virtual environment for associate and customer interaction. The interaction provides module testing for physical environment triggered deployment.

### BACKGROUND

Currently, physical deployment of software modules lead to inconsistent network connections across legacy system programing and modern program and product implementation. As such, a need exists for low network vulnerability roll out of modules in a decentralized environment for subsequent physical deployment.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

Systems, computer program products, and methods are described herein for a decentralized virtual environment platform with transition modules between virtual and physical environments. The present invention is configured to allocate modules in a virtual environment for associate and customer interaction. The interaction provides module testing for physical environment triggered deployment. The invention provides for a decentralized environment for training in a secure testing environment with minimal chance of misappropriation and cross contamination into a physical environment. The invention provides a solution to the technical problem of how to test products for physical world deployment without introduction of the products to the physical world and of how to predict user fiscal responsibility in the physical world where there is limited data points or experience.

The system generates a training module in a virtual environment that is secure and not likely to interact with or cause issues in a physical environment. These modules provide a way for software system testing, associate software and scenario training and experience, and customer product training. The system allows for a two-sided benefit. First, it allows for the entity to test and deploy products with low danger to physical world systems. Second, it allows for an individual in the virtual environment to build experience and training with low danger or implication in the physical world systems. The platform tracks product testing and the user experience and allows for the deployment and translation of the module utilization in the virtual environment to the physical environment for seamless translation of experience for the user and the product.

The invention comprises a system, method, and computer program product for a decentralized environment for physical environment component deployment, the invention comprising: establishing modules for deployment from a decentralized platform in a virtual environment, reviewing user history and generate tolerance level for user module deployment in the virtual environment; presenting modules to the user in the virtual environment based on user physical environment requirements and upstream user inputs; monitoring module implementation and link the user module implementation to the upstream user; and triggering a cross module implementation from the virtual environment to a physical environment for physical environment implementation of a product or software associated with the module.

In some embodiments, the cross module implementation further comprises deployment of the product or the software associated with the module in the physical environment for physical use of the product or the software.

In some embodiments, the modules comprise code for displaying a virtual session in a virtual environment for training for a financial product or financial entity software.

In some embodiments, the tolerance level for user module deployment in the virtual environment is based on the user experience with a product or software.

In some embodiments, the upstream user is linked to the user in the decentralized platform for the upstream user to review module completion and user interaction on the virtual environment.

In some embodiments, the virtual environment of the user and the virtual environment of the upstream user are linked and shared for module transitioning between the virtual environments.

In some embodiments, the upstream user is a manager or guardian of the user.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrates technical components of an exemplary distributed computing environment for a decentralized environment trainer for physical deployment, in accordance with an embodiment of the invention;

FIG. 2 illustrates a process flow for the decentralized environment trainer for physical deployment, in accordance with an embodiment of the invention; and

FIG. 3A-3B illustrates a process flow for module distribution within the decentralized environment trainer, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity. The user may be an associate of the entity. The user may also be a customer of the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a virtual environment may be accessed by an end point device and may include a virtual reality environment, an augmented reality environment, or an extended reality environment. While a physical environment may include a real-world environment outside of a virtual environment.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this invention, a resource is typically stored in a resource repository—a storage location where one or more resources are organized, stored and retrieved electronically using a computing device.

Systems, computer program products, and methods are described herein for a decentralized virtual environment platform with transition modules between virtual and physical environments. The present invention is configured to allocate modules in a virtual environment for associate and customer interaction. The interaction provides module testing for physical environment triggered deployment. The invention provides for a decentralized environment for training in a secure testing environment with minimal chance of misappropriation and cross contamination into a physical environment. The invention provides a solution to the technical problem of how to test products for physical world deployment without introduction of the products to the physical world and of how to predict user fiscal responsibility in the physical world where there is limited data points or experience.

The system generates a training module in a virtual environment that is secure and not likely to interact with or cause issues in a physical environment. These modules provide a way for software system testing, associate software and scenario training and experience, and customer product training. The system allows for a two-sided benefit. First, it allows for the entity to test and deploy products with low danger to physical world systems. Second, it allows for an individual in the virtual environment to build experience and training with low danger or implication in the physical world systems. The platform tracks product testing and the user experience and allows for the deployment and translation of the module utilization in the virtual environment to the physical environment for seamless translation of experience for the user and the product.

Currently, physical deployment of software modules lead to inconsistent network connections across legacy system programing and modern program and product implementation. As such, a need exists for low network vulnerability roll out of modules in a decentralized environment for subsequent physical deployment. What is more, the present invention provides a technical solution to a technical problem. As described herein, the technical problem includes improving network speed and latency issues with product or software roll out into a physical environment by providing a virtual environment test center. The technical solution presented herein allows for virtual environment rollout and testing, with seamless physical world integration and product deployment. In particular, the decentralized platform is an improvement over existing solutions to the physical environment product congruency (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

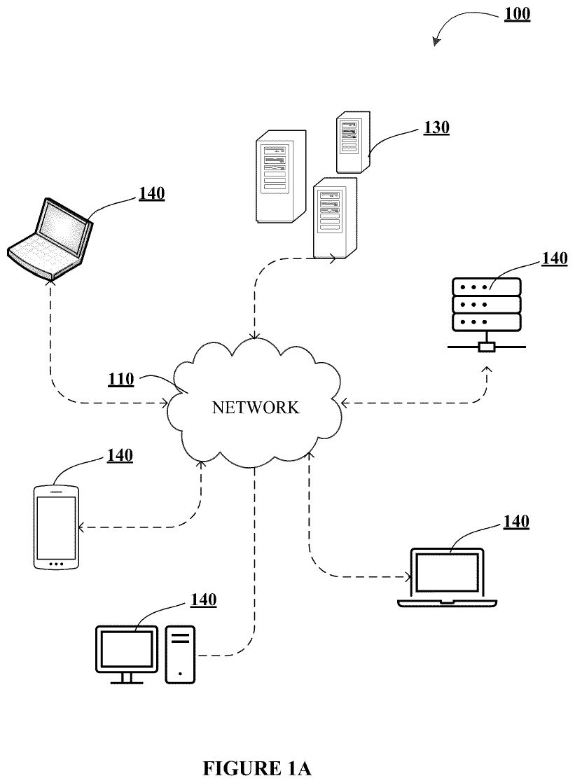

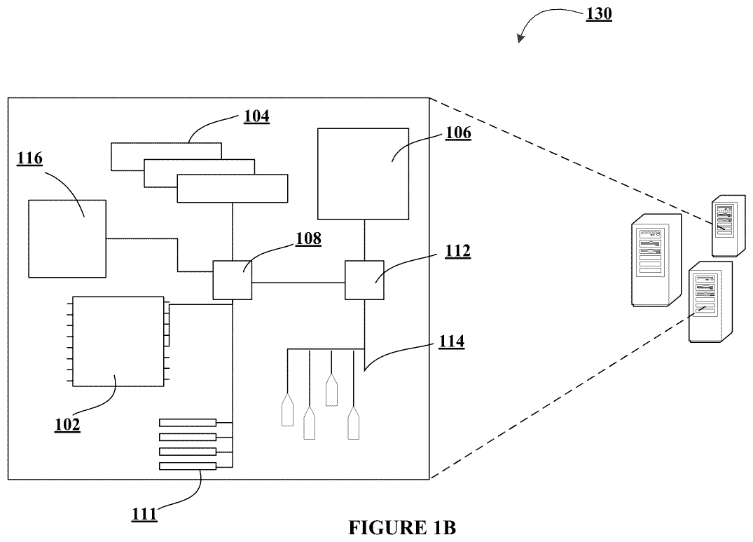

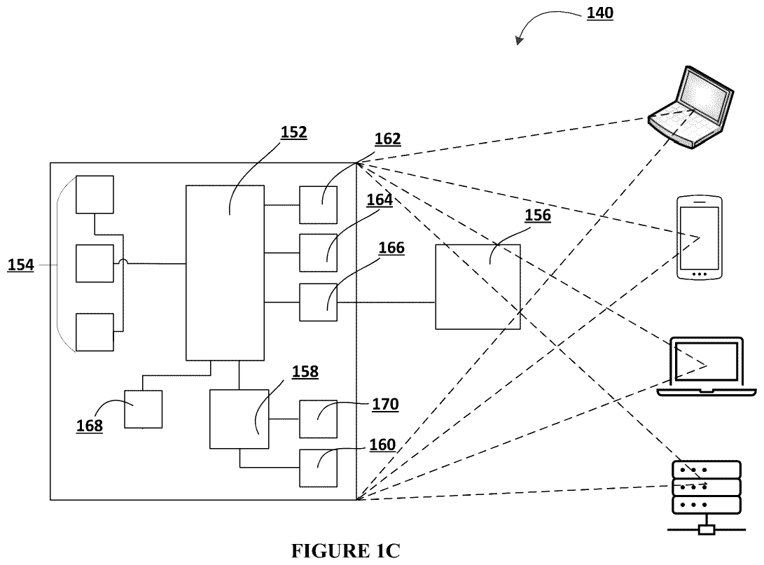

FIGS. 1A-1C illustrate technical components of an exemplary distributed computing environment for a decentralized environment trainer for physical deployment 100, in accordance with an embodiment of the invention. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like. The end-point device 140 may include a virtual reality device, augmented reality device, or extended reality device for accessing the virtual environment.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate. The end-point device(s) 140 may include an access module for accessing a virtual environment. In this way, the end-point devices(s) 140 may include a virtual reality device, augmented reality device, or extended reality device for accessing the virtual environment.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

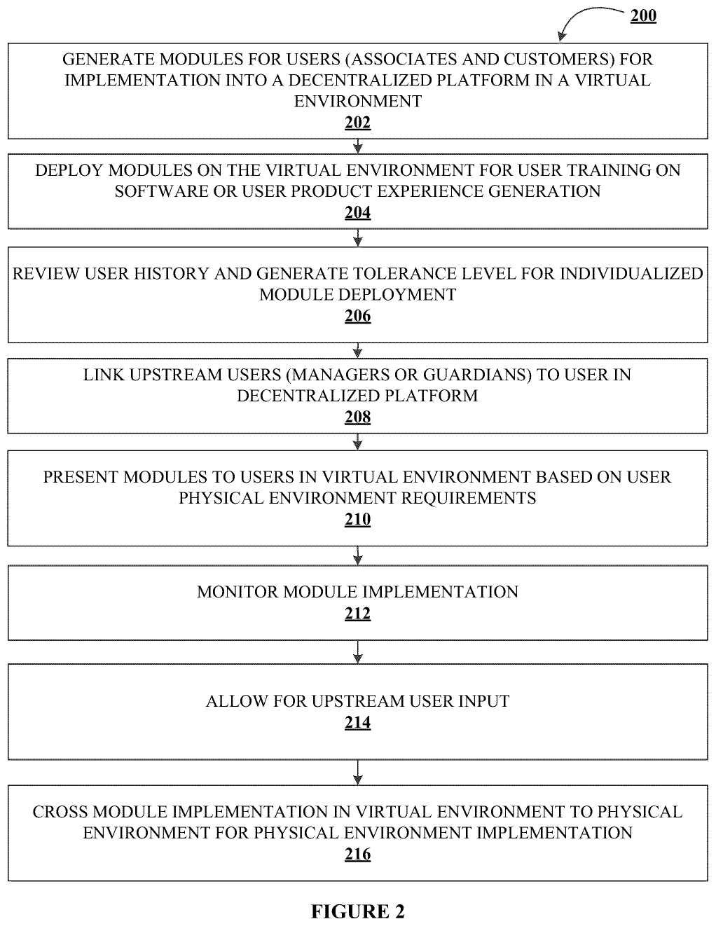

FIG. 2 illustrates a process flow for the decentralized environment trainer for physical deployment 200, in accordance with an embodiment of the invention. As illustrated in block 202, the process 200 is initiated by generating modules for users for implementation into a decentralized platform in a virtual environment. These modules may be for users, such as associates affiliated with an entity or for users, such as customers of the entity. For associates, the modules may include virtual experiences for training for the interaction with customers, virtual experiences for training for the use of software, or virtual experiences for training for the integration of software into an entity environment. In this way, the system and users may be able to test software, hardware, or customer interaction methods in a low stress virtual environment prior to physical environment roll out.

For customers, the modules may include virtual experiences for training for the user of products provided by the entity, such as financial products, virtual experiences for training for the use of software associated with the entity, or virtual experiences for training for the integration of software into the customer applications. In this way, the user may be able to test products of an entity or software of an entity in a low stress virtual environment prior to physical environment roll out of the product for the customer.

The modules may be used for user training and user experience in a low stress environment. That way associates or customers may be able to learn products, software, or the like in a low stress virtual environment prior to physical environment implementation. The modules may include products, such as financial institution products that a user may be interested in. The module may be implemented with the user in the virtual environment to illustrate how the product may work within the user's current financial state. The user may be able to manipulate funds, manipulate products, or the like in the virtual environment to test the product with the user's current financial state to learn the product and learn if the product works for the user.

Next, as illustrated in block 204, the process 200 continues by deploying the modules on the virtual environment for user training on software or user product experience generation. In this way, the system may build modules for deployment on a virtual environment. These modules may contain program code for the interaction of scenarios with a user. These scenarios may include selection and use of a financial institution product. For example, the system may provide a module for a user to virtually sign up for an account, activate the account, and use the account in a virtual environment to learn how the account operates as well as gain an understanding of the account and how it impacts the user. In this way, the module allows the user to test software, products, or scenarios in a virtual low stress environment. In some embodiments, the module may comprise software associated with the entity. The module may allow user interaction with the software in an entity environment. In this way, this allows the associate associated with the entity to test and use software to learn the software, identify how the software interacts with entity infrastructure, and the like prior to physical deployment.

As illustrated in block 206, the process 200 continues by reviewing user history and generate tolerance levels for individualized module deployment. In this way, each module is tailored to each user. Some modules may be more detailed with respect to the virtual environment, more detailed with respect to the steps of a process of a product or software, and/or the like. Furthermore, the system may tailor the modules for user experiences. For example, if a user has previous experience with a savings account, but has never had experience with a checking account, the system may tailor a module to start the process of enrolling in a checking account and using a checking account. However, if the user has had past experience with a checking account, but is learning additional features, the module may tailor to those product features. As such, based on user experience with a product or suite of products, the system is able to deploy user specific tolerance level modules associated with the product.

As illustrated in block 208, the process 200 continues by linking upstream users to the user in the decentralized platform. Upstream users may include guardians of customers and/or managers of associates. When linked, the upstream users may be able to view the progress of module completion of the user, provide additional modules for user completion, and monitor status of module competency.

The system may present modules to the users in a virtual environment, based on the user physical environment requirements, as illustrated in block 210. In this way, based on upstream user recommendation, user experience, user tolerance, user training needs, user product needs, or the like, the system may determine and provide the use with one or more modules in the virtual environment based on the user physical environment requirements. The system may monitor module implementation, as illustrated in block 212. In this way, the system may monitor the stage or completion of one or more modules that the user is engaged in within the virtual environment. The system may also monitor or grade the portions of the module that a user completed within the virtual environment.

As illustrated in block 214, the process 200 continues by presenting the monitoring module implementation of the user to upstream users for upstream user input. In this way, allowing guardians or managers of users to review module completion, watch playbacks of module interaction by a user, and the grade of the portion of the modules the user completed.

Finally, as illustrated in block 216, the system may trigger a cross module implementation from the virtual environment to the physical environment for physical environment implementation of the product or software associated with the module. In this way, once the modules associated with a product or software have been tested in the virtual environment, the system may trigger implementation of the product into a user suite or the software into the entity network in the physical environment.

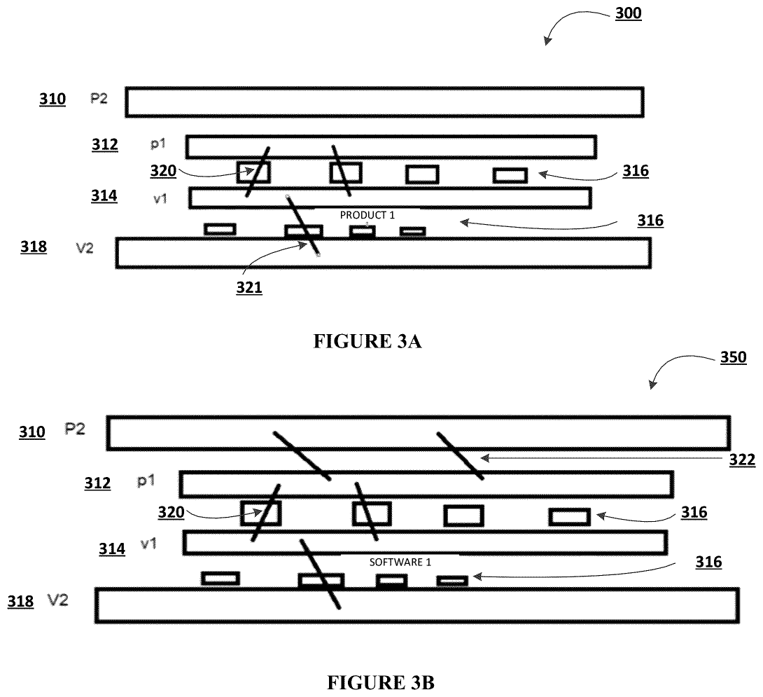

FIG. 3A illustrates a process flow for module distribution within the decentralized environment trainer 300, in accordance with an embodiment of the invention. As illustrated in FIG. 3A, there are layers of a user in a physical environment p1 312 and the same user interacting in a virtual environment v1 314. There is also an upstream user in a physical environment p2 310 and the same upstream user also interacting in their own virtual environment v2 318. In the example displayed in FIG. 3A, the user is a customer testing a product, Product 1 in their virtual environment 314 for implementation into the user's physical environment 312. As illustrated, there are one or more modules 316 for the user to interact with in the virtual environment 314. The user may interact with the modules in the virtual environment 314 to test the product, interact with the product, learn about the product, and the like. The upstream user may identify one or more product modules for user completion and push them from the upstream user virtual environment 318 to the user's virtual environment 314, as illustrated in 321. Furthermore, the user may trigger the implementation of the product in the user's physical environment 312, as illustrated 320.

FIG. 3B illustrates a process flow for module distribution within the decentralized environment trainer 350, in accordance with an embodiment of the invention. As illustrated in FIG. 3B, there are layers of a user in a physical environment p1 312 and the same user interacting in a virtual environment v1 314. There is also an upstream user in a physical environment p2 310 and the same upstream user also interacting in their own virtual environment v2 318. In the example displayed in FIG. 3B, the user is an associate with an entity testing software, Software 1 in their virtual environment 314 for implementation into either the user's physical environment 312, the upstream user's physical environment 310, or entity wide. As illustrated, there are one or more modules 316 for the user to interact with in the virtual environment 314 to test the software or learn the software. The user may interact with the modules in the virtual environment 314 to test the software, interact with the software, learn about the software, see how the software interacts with the entity suite of applications, and the like. The upstream user may identify one or more product modules for user completion and push them from the upstream user virtual environment 318 to the user's virtual environment 314. Furthermore, the user may trigger the implementation of the software in the user's physical environment 312 as illustrated in 320 or in the upstream user's physical environment 322, or entity wide.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for a decentralized environment for physical environment component deployment, the system comprising:
at least one non-transitory storage device; and
at least one processor coupled to the at least one non-transitory storage device, wherein the at least one processor is configured to:
establish modules for deployment from a decentralized platform in a virtual environment;
review user history and generate tolerance level for user module deployment in the virtual environment;
present modules to the user in the virtual environment based on user physical environment requirements and upstream user inputs;
monitor module implementation and link the user module implementation to the upstream user; and
trigger a cross module implementation from the virtual environment to a physical environment for physical environment implementation of a product or software associated with the module.

2. The system of claim 1, wherein the cross module implementation further comprises deployment of the product or the software associated with the module in the physical environment for physical use of the product or the software.

3. The system of claim 1, wherein the modules comprise code for displaying a virtual session in a virtual environment for training for a financial product or financial entity software.

4. The system of claim 1, wherein the tolerance level for user module deployment in the virtual environment is based on the user experience with a product or software.

5. The system of claim 1, wherein the upstream user is linked to the user in the decentralized platform for the upstream user to review module completion and user interaction on the virtual environment.

6. The system of claim 1, wherein the virtual environment of the user and the virtual environment of the upstream user are linked and shared for module transitioning between the virtual environments.

7. The system of claim 1, wherein the upstream user is a manager or guardian of the user.

8. A computer program product for a decentralized environment for physical environment component deployment, the computer program product comprising a non-transitory computer-readable medium comprising code causing an apparatus to:
establishing modules for deployment from a decentralized platform in a virtual environment;
reviewing user history and generate tolerance level for user module deployment in the virtual environment;
presenting modules to the user in the virtual environment based on user physical environment requirements and upstream user inputs;
monitoring module implementation and link the user module implementation to the upstream user; and
triggering a cross module implementation from the virtual environment to a physical environment for physical environment implementation of a product or software associated with the module.

9. The computer program product of claim 8, wherein the cross module implementation further comprises deployment of the product or the software associated with the module in the physical environment for physical use of the product or the software.

10. The computer program product of claim 8, wherein the modules comprise code for displaying a virtual session in a virtual environment for training for a financial product or financial entity software.

11. The computer program product of claim 8, wherein the tolerance level for user module deployment in the virtual environment is based on the user experience with a product or software.

12. The computer program product of claim 8, wherein the upstream user is linked to the user in the decentralized platform for the upstream user to review module completion and user interaction on the virtual environment.

13. The computer program product of claim 8, wherein the virtual environment of the user and the virtual environment of the upstream user are linked and shared for module transitioning between the virtual environments.

14. The computer program product of claim 8, wherein the upstream user is a manager or guardian of the user.

15. A method for a decentralized environment for physical environment component deployment, the method comprising:
establishing modules for deployment from a decentralized platform in a virtual environment;
reviewing user history and generate tolerance level for user module deployment in the virtual environment;
presenting modules to the user in the virtual environment based on user physical environment requirements and upstream user inputs;
monitoring module implementation and link the user module implementation to the upstream user; and
triggering a cross module implementation from the virtual environment to a physical environment for physical environment implementation of a product or software associated with the module.

16. The method of claim 15, wherein the cross module implementation further comprises deployment of the product or the software associated with the module in the physical environment for physical use of the product or the software.

17. The method of claim 15, wherein the modules comprise code for displaying a virtual session in a virtual environment for training for a financial product or financial entity software.

18. The method of claim 15, wherein the tolerance level for user module deployment in the virtual environment is based on the user experience with a product or software.

19. The method of claim 15, wherein the upstream user is linked to the user in the decentralized platform for the upstream user to review module completion and user interaction on the virtual environment.

20. The method of claim 15, wherein the virtual environment of the user and the virtual environment of the upstream user are linked and shared for module transitioning between the virtual environments.
